(19) United States
(12) Patent Application Publication
(10) Pub. No.: US 2026/0024911 A1
(43) Pub. Date: Jan. 22, 2026

(54) ANTENNA FOR USE IN A MARINE ELECTRONICS DEVICE

(71) Applicant: Navico Group Americas, LLC, Menomonee Falls, WI (US)

(72) Inventors: Kaisar Nurkhal, Auckland (NZ); Ricardo Perez, Auckland (NZ)

(21) Appl. No.: 18/778,326

(22) Filed: Jul. 19, 2024

(51) Int. Cl. H01Q 1/34; H01Q 1/22; H01Q 1/48; H01Q 1/50; H01Q 9/04

(52) U.S. Cl. CPC H01Q 1/34; H01Q 1/22; H01Q 1/48; H01Q 1/50; H01Q 9/0421

(57) ABSTRACT

Electronic devices and antenna systems/assemblies for mounting in a dash of a watercraft are provided herein. The electronics device comprises a liquid crystal display (LCD) comprising a screen defining a first surface opposing a second surface, and a frame attached to the second surface. The frame is a conductive material. The electronics device further comprises at least one antenna element attached to the frame of the LCD. The at least one antenna element defines a radiating element for transmitting and receiving a wireless signal and a ground portion each extending in parallel planes. The ground portion is attached to and in electrical communication with the frame. The electronics device further comprises a cable extending from the ground of the at least one antenna, wherein the cable enables data communication between the at least one antenna and a printed circuit board.

### FIELD

Embodiments of the present invention relate generally to marine electronics devices and, more particularly, to the configuration of and position of antenna elements within marine electronics devices for positioning into a watercraft.

### BACKGROUND

Electronic devices such as portable computers, cellular phones, and marine electronics devices are often provided with wireless communication capabilities. The electronics devices may be contained in a metal housing, and in general may be designed having antennas that are disposed external to or embedded within the housing of such wireless device.

Marine electronics devices may be used in various spaces on a watercraft and may include at least one marine electronics device positioned at a central location, for example, at the helm or steering center. The helm, or steering center, of many watercrafts, however, often includes a metal dash which surrounds the marine electronics device.

The combination of the marine electronics device housing, and the metal dash may interfere with antenna performance, as both the comprise metal housings Antenna performance is adversely affected in such an environment as the metal housing, and metal dash form an enclosure about the antenna which only includes a narrow opening for radio waves to propagate through. Interference may be reduced and/or avoided by positioning the antenna away from such metal components. However, positioning the antenna in such a manner still results in reduced performance and space constraint issues.

### BRIEF SUMMARY OF THE INVENTION

Given the foregoing, there is a desire to provide a marine electronics device with an antenna arrangement that provides improved wireless transmission capabilities, even when positioned in a metal dash. The antenna arrangement utilizes a planar inverted F antenna (PIFA) secured onto the back surface of a LCD screen, rather than the side, as in previous devices. Positioning the PIFA on the back surface of the LCD allows a housing to cover the antenna and be positioned between the antenna and the dash.

The housing enclosing the antenna provides the requisite clearance between the metal dash and the antenna, to allow electromagnetic waves to travel to and from the antenna, without any additional space between the marine electronics device and the dash. Thus, the marine electronics device may be flush with the metal dash. Additionally, since the housing comprises a plastic or dielectric material, the housing provides a path for electromagnetic waves, without interference from the metal in the dash.

The present invention includes a marine electronics device for mounting in the dash, both metal and nonmetal, of a watercraft. The marine electronics device includes a display screen defining a first surface opposing a second surface, and a conductive frame attached to the second surface of the display. At least one antenna element is attached to the frame of the display. The at least one antenna element includes a radiating element and a ground portion wherein the ground portion and the radiating element extend in parallel planes. The ground portion is in electrical communication with the conductive bracket, thereby causing the conductive frame to act as an extension of the ground of the at least one antenna. By making the frame a resonant structure of the at least one antenna, the radiated signal strength increases even when mounted in a metal dash.

In an example embodiment, a marine electronics device for mounting in a dash of a watercraft is provided. The marine electronics device comprises a liquid crystal display (LCD) comprising a screen defining a first surface opposing a second surface, and a conductive frame attached to the second surface of the screen. The marine electronics device further comprises at least one antenna element attached to the frame of the LCD. The at least one antenna element defines a radiating element for transmitting and receiving a wireless signal and a ground portion. The radiating element and the ground portion extend in parallel planes. The ground portion is attached to and in electrical communication with the frame of the LCD. The marine electronics device further comprises a cable extending from the ground of the at least one antenna element. The cable enables data communication between the at least one antenna element and a printed circuit board.

In some embodiments, the at least one antenna element may be a planar inverted F antenna. In some embodiments, the marine electronics device may further comprise a support positioned between the ground portion and the radiating element of the at least one antenna element. In some embodiments, the support may be a non-conductive material.

In some embodiments, the at least one antenna element may be a first antenna and a second antenna. The first antenna may be positioned on a first edge of the frame and the second antenna may be positioned on a second edge of the frame, and the first edge and the second edge may be different. In some embodiments, the first edge and the second edge may be opposite.

In some embodiments, the marine electronics device may further comprise a housing which encloses the frame and the second surface of the LCD. In some embodiments, the housing may circumscribe the first surface of the LCD. In some embodiments, the housing may further enclose the printed circuit board. In some embodiments, the housing may be comprised of a dielectric material. In some embodiments, the housing may be plastic.

In another example embodiment, an assembly inside a housing of an electronics device for mounting within a dash of a watercraft is provided. The assembly comprises a display defining a first surface and a second surface opposite the first surface. The assembly further comprises a frame attached to the second surface of the display, the frame being a conductive material. The assembly further comprises an antenna element having a radiating element for transmitting and receiving a wireless signal and a ground portion. The radiating element and the ground portion extend in parallel planes. The ground portion is attached to and in electrical communication with the frame. The assembly further comprises an antenna signal feeding line coupled to the antenna element. The antenna signal feeding line being in data communication with a printed circuit board.

In some embodiments, the antenna element may be a planar inverted F antenna. In some embodiments, the antenna element may be a first antenna and a second antenna. The first antenna may be connected to a first edge of the frame and the second antenna may be connected to a second edge of the frame, the first and second edges being different. In some embodiments, the assembly may further comprise a support positioned between the radiating element and the ground portion of the antenna element. In some embodiments, the support may be a dielectric material.

In yet another example embodiment, a marine electronics device positioned in a metal dash of a watercraft is provided. The marine electronics device comprises a liquid crystal display (LCD) comprising a screen defining a first surface opposing a second surface. A conductive frame is attached to the second surface of the screen. The marine electronics device further comprises at least one planar inverted F antenna (PIFA) element attached to the frame of the LCD. The at least one PIFA element defines a radiating element for transmitting and receiving a wireless signal and a ground portion, extending in parallel planes. The ground portion being attached to and in electrical communication with the frame of the LCD. The marine electronics device further comprises a cable extending from the ground portion of the at least one PIFA element. The cable enables data communication between the at least one PIFA element and a printed circuit board.

In some embodiments, the marine electronics device may further comprise a support positioned between the ground portion and the radiating element of the PIFA element. In some embodiments, the support may be a non-conductive material. In some embodiments, the at least one PIFA element may be a first PIFA positioned on a first edge of the frame and a second PIFA element positioned on a second edge of the frame, and the first edge and the second edge may be different.

### BRIEF DESCRIPTION OF THE DRAWINGS

Reference will now be made to the accompanying drawings, which are not necessarily drawn to scale, and wherein:

FIG. 1 illustrates an example watercraft including various marine devices, in accordance with some embodiments discussed herein;

FIG. 2 illustrates a helm of a watercraft, including multiple example marine electronics devices, in accordance with some embodiments discussed herein;

FIG. 3A illustrates a perspective view of the front of a marine electronics device in a dash, in accordance with some embodiments discussed herein;

FIG. 3B illustrates a perspective view of the rear of a marine electronics device in a dash, in accordance with some embodiments discussed herein;

FIG. 4A illustrates a cross sectional view of the marine electronics device in a dash shown in FIG. 3A, taken along line A-A, in accordance with some embodiments discussed herein;

FIG. 4B illustrates a cross sectional view of the marine electronics device in a dash shown in FIG. 3A, taken along line B-B, in accordance with some embodiments discussed herein;

FIG. 4C illustrates a close-up view of the portion of the marine electronics device in the dash shown in FIG. 4B within circle C-C, in accordance with some embodiments discussed herein; and

FIG. 5 illustrates an antenna element positioned within a marine electronics device, in accordance with some embodiments discussed herein.

### DETAILED DESCRIPTION

Example embodiments of the present invention now will be described more fully hereinafter with reference to the accompanying drawings, in which some, but not all embodiments of the invention are shown. Indeed, the invention may be embodied in many different forms and should not be construed as limited to the example embodiments set forth herein; rather, these embodiments are provided so that this disclosure will satisfy applicable legal requirements. Like reference numerals refer to like elements throughout.

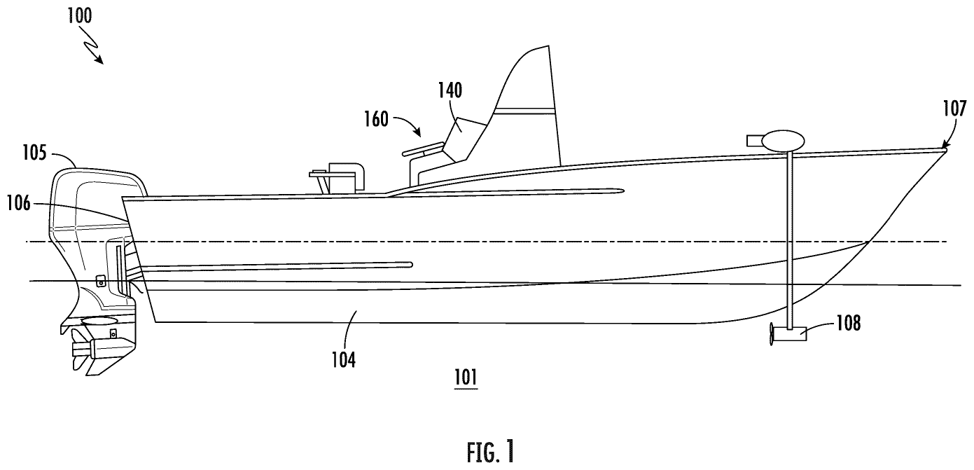

FIG. 1 illustrates an example watercraft 100 including various marine devices, in accordance with some embodiments discussed herein. As depicted in FIG. 1, the watercraft 100 (e.g., a vessel) is configured to traverse a marine environment, e.g., body of water 101, and may use one or more sonar transducer assemblies disposed on and/or proximate to the watercraft. Notably, the example watercraft 100 contemplated herein may be a surface watercraft, a submersible watercraft, or any other implementation known to those skilled in the art. The transducer assemblies may each include one or more transducer elements configured to transmit sound waves into a body of water, receive sonar returns from the body of water, and convert the sonar returns into sonar return data.

Depending on the configuration, the watercraft 100 may include a primary motor 105, which may be a main propulsion motor such as an outboard or inboard motor located at the stern 106 of the watercraft. Additionally, the watercraft 100 may include the trolling motor 108 configured to, for example, propel the watercraft 100 and/or maintain a position. In the illustrated embodiment, the trolling motor 108 is located at the fore 107 of the watercraft 100, but other positions are located.

The watercraft 100 may also include one or more marine electronics devices 140, such as may be utilized by a user to interact with, view, or otherwise control various functionality regarding the watercraft, including, for example, nautical charts and various sonar systems. In the illustrated embodiment, the marine electronics device 140 may be positioned proximate the helm 160 (e.g., steering wheel) of the watercraft 100—although other places on the watercraft 100 are contemplated.

The watercraft 100 may also comprise other components, such as within the one or more marine electronics devices 140 or at the helm 160. In some embodiments, the watercraft 100 may also comprise an AIS transceiver and/or a direction sensor, and these components may be positioned at or near the helm (although other positions relative to the watercraft are also contemplated). In other embodiments, these components may be integrated into the one or more marine electronic devices 140 or other devices. Other example devices include a wind sensor, one or more speakers, and various vessel devices/features (e.g., doors, bilge pump, fuel tank, etc.), among other things. Additionally, one or more sensors may be associated with marine devices; for example, a position sensor may be provided to detect the position of various marine devices individually.

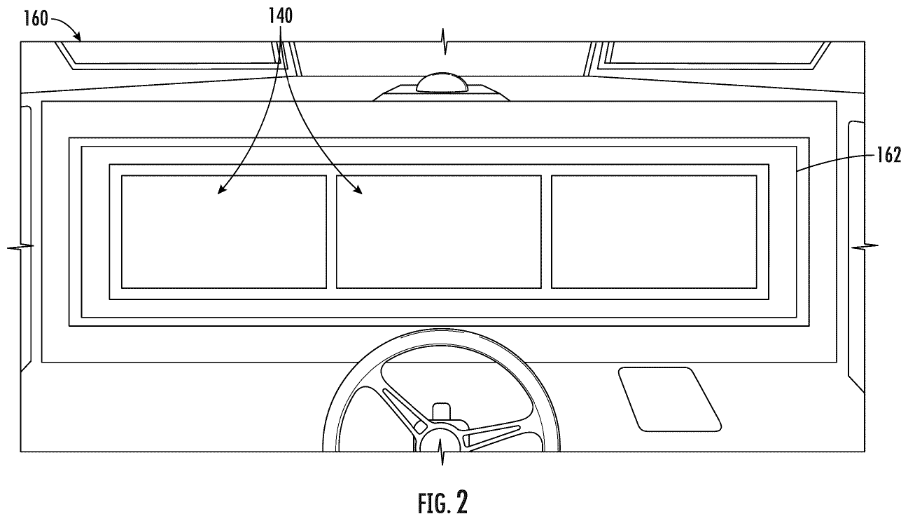

FIG. 2 illustrates an example helm 160 of the watercraft 100. In some embodiments, the helm 160 may include one or more marine electronics devices 140 embedded within a dash 162. Notably, the dash 162 may completely surround the marine electronics device 140 on all sides (although three marine electronic devices are shown, many times a single marine electronic device is positioned within the dash and completely surrounded). Marine electronics devices may be utilized in various tasks, for example, navigation, fish finding, data presentation, communication, etc. As the functionality of the marine electronics devices increases, many watercrafts, increase the number of marine electronics devices used on board and/or increase the size of the marine electronics devices. Thus, the space at the helm 160 is reduced, and must be utilized efficiently.

Marine electronics devices 140 are equipped to transmit and receive data with external devices through wireless communication using an antenna. The performance of the marine electronics device (e.g., speed, reliability, latency, bandwidth, etc.) may vary depending on various components of the marine electronics device including, processors, memory, and/or the antenna. Notably, in some embodiments, the dash 162 may be a metal material, for example, aluminum, stainless steel or the like, which may interfere with signals received and emitted by components of the marine electronics device 140, for example the antenna, thereby degrading the performance of the antenna and thus the marine electronics device.

To explain further, the metal dash 162 may prevent, partially block, and/or scatter radio frequencies from entering or exiting the confines of the dash. Metal may block (partially or fully) and/or scatter radio frequencies due to its conductive properties and may reflect any electromagnetic waves. In this regard, the dash, when formed from metal, may obstruct or interfere with radio frequencies in the vicinity of the dash 162. This presents a unique issue for positioning the marine electronics device 140 at the helm 160 and specifically within the dash 162 of a watercraft.

Additionally, as the functionality of the marine electronics devices increase, the computing power and connectivity of the marine electronics devices increases. Thus, there are more components positioned within the housing. In prior watercraft configurations, for the marine electronics device to adequately receive radio frequencies to function at a high capacity, a gap of, for example, at least 10 mm was required between the antenna, which was positioned on a side of the marine electronics device and the metal dash. The gap between the marine electronics device and the dash caused dust, water, and other elements to become positioned behind the marine electronics device, and in addition to not being aesthetically pleasing, the devices may have to be removed and cleaned out behind. However, as discussed the space at the helm is designed to be used efficiently, and the extra space, or gap, decreases both the efficiency and the aesthetics of the helm.

Thus, as the size of the marine electronics devices 140 increase, the space available between the marine electronics device decreases, while the need for reliable and high-speed transmission increases. This poses an issue for the traditional configuration of antennas within the marine electronics devices as the requisite space needed for interfered transmission decreases. In this regard, changing the configuration of the antenna within the marine electronics device provides more space for larger marine electronics devices or a reduced footprint for such marine electronics devices.

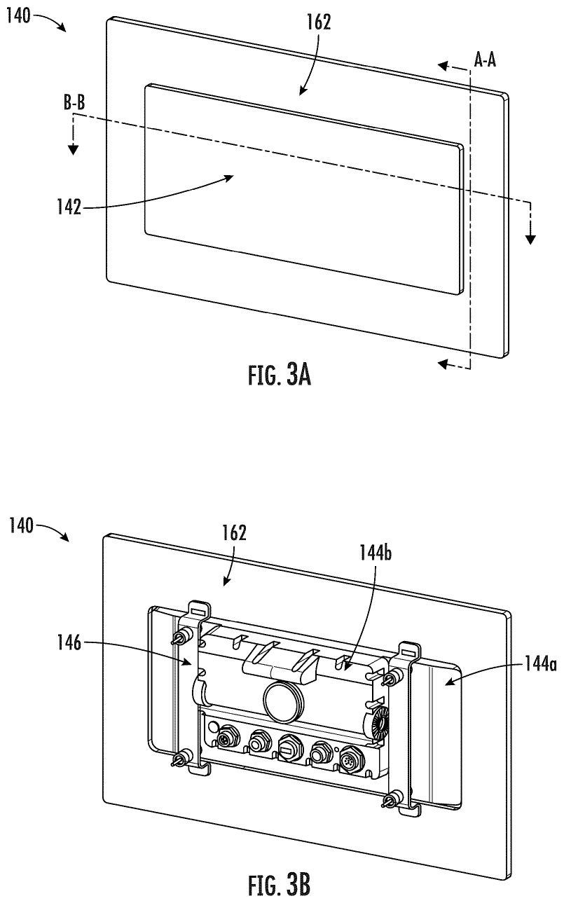

FIGS. 3A-B illustrate an example marine electronics device 140 positioned within a dash 162. In some embodiments, the marine electronics device 140 may be positioned at the helm of the watercraft, or otherwise positioned within the watercraft.

The marine electronics device 140 may comprise a liquid crystal display (LCD). The LCD may comprise a screen 142 which is a customer facing structure. In some embodiments, the screen 142 may be flush with the dash 162, while in other embodiments the screen 142 may protrude outwardly from the dash 162.

As illustrated in FIG. 3B, the marine electronics device 140 may have a housing enclosing the display. The housing may be comprised of a first housing 144a and a second housing 144b. In some embodiments, the first housing 144a may enclose the display 142, and the second housing 144b may enclose various electronic components. In some embodiments, the first housing 144a and the second housing 144b may be a single unit, while in other embodiments, the first housing 144a and the second housing 144b may be distinct from one another.

The first housing 144a and the second housing 144b may be formed of the same material or may be formed of distinct materials. In some embodiments, each of the first housing 144a and the second housing 144b may be formed of a plastic, and/or another dielectric material. As will be discussed herein, the use of plastic in the first housing 144a and the second housing 144b, and the spacing of the first housing 144a and the second housing 144b provides a pathway for electromagnetic waves. Said differently, when a metal dash 162 completely surrounds the LCD screen 142, which contains metal, there is no pathway for electromagnetic waves due to the interference from the metal in the dash and the LCD screen. Thus, the use of plastic or other dielectric material in the housing provides a pathway for the electromagnetic waves to propagate through, and be received and/or emitted from the antenna 130 positioned within the housing 140. Thus, the housing 140 may encase the second surface and edges of the LCD screen preventing contaminants from entering into the device, while beneficially providing a pathway for the signals.

The marine electronics device 140 may be secured to the dash 162 through one or more brackets 146. The one or more brackets 146 may engage the first housing 144a, the second housing 144b, and the dash 162 to secure the position of the marine electronics device 140 therein.

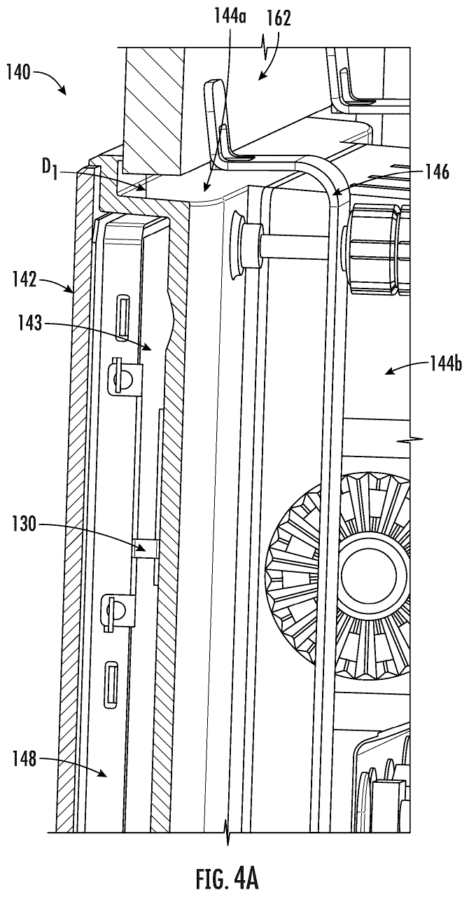

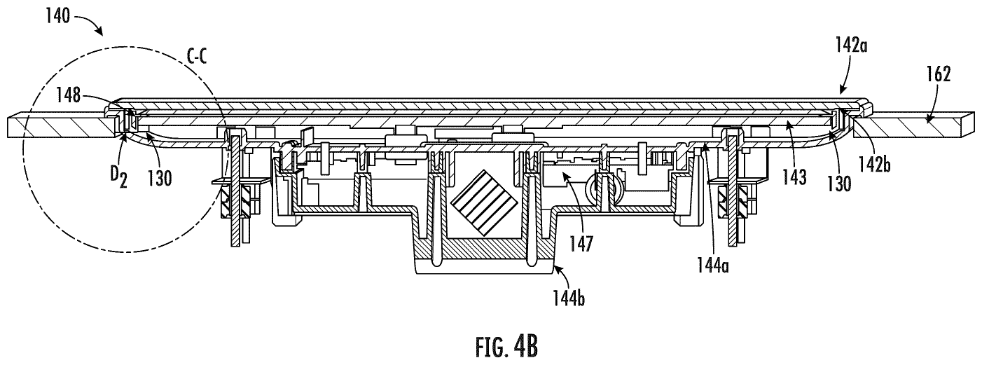

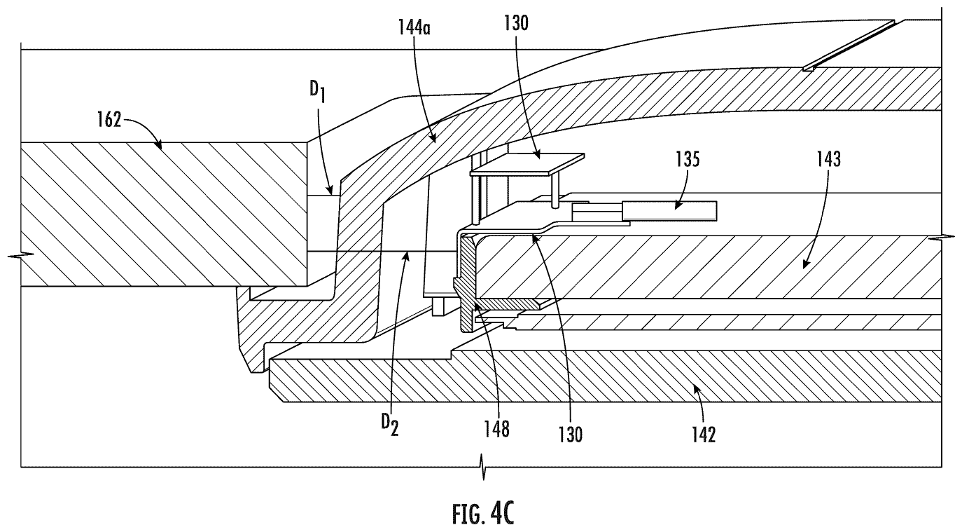

FIGS. 4A-C illustrate the interior of the marine electronics device 140 more fully and the example positioning of the components within. FIG. 4A illustrates a cross-sectional view taken along line A-A of FIG. 3A of the marine electronics device 140 secured to the dash 162 via the bracket 146.

As illustrated, the LCD screen 142 may have a frame 143 attached to a second surface (see 142b FIG. 4B). In some embodiments, the frame 143 may be a conductive material, for example a metal. The frame 143 may be attached to the screen 142 and may extend to, but not beyond the periphery of the screen 142. In this regard, in some embodiments the frame 143 may be flush with the perimeter of the screen 142, and in other embodiments, the frame 143 may be spaced apart from the perimeter of the screen 142.

In some embodiments, a frame mount 148 may circumscribe the frame 143 and provide a surface for mounting components to the LCD screen 142. The frame mount 148 may comprise a plastic material or similar material which may provide a surface for multiple types of mounting, for example, physical mounting via screws, or similar, and/or adhesive mounting. Additionally, the frame mount 148 may provide a buffer or barrier for any ports or connection points for the LCD screen 142.

As will be described further herein, an antenna 130 may be positioned on the frame mount 148. In some embodiments, the antenna 130 may be positioned parallel to the frame 143 and/or the screen 142. In this regard, rather than be positioned on the side surface of the screen 142 or housing 144, the antenna is positioned on the LCD 142, via the frame mount 148.

The marine electronics device 140 may be enclosed with multiple housings and/or housing components. In an example embodiment, the first housing 144a may be positioned around the periphery of the LCD screen 142, specifically to enclose the screen 142, the frame 143, the frame mount 148, the antenna 130, and any some electrical connections. In some embodiments, the first housing 144a may separate the dash 162 from the LCD screen 142, the frame 143, the antenna 130, and other components.

The first housing 144a may be flush with or overlap the dash 162 on a customer facing side of the LCD screen 142. In this regard, there may be no water ingress, or contaminates able to enter into the marine electronics device 140 via the front surface. In contrast, the first housing 144a may be spaced a first distance D₁ from the dash 162 on a back side, or non-customer facing side. The first distance D₁ may provide a necessary space between the antenna 130 and the metal dash 162 to improve the signal processing and transmission of the antenna 130.

In some embodiments, the second housing 144b may positioned over a second portion of the marine electronics device 140. The second portion of the marine electronics device 160 may include a printed circuit board, and other electronics which provide various functionality for the marine electronics device 140. The second housing 144b may be positioned internal to the dash 162 (e.g., non-customer facing). In some embodiments, the second housing 144b may formed of the same material as the first housing 144a, while in other embodiments the first housing 144a and the second housing 144b may comprise different materials.

The bracket 146 may be positioned about a non customer-facing side of one or both of the first housing 144a and the second housing 144b. The bracket 146 may secure the marine electronics device 140 to the internal (e.g., non-customer-facing) side of the dash 162, thereby securing the marine electronics device 140 in place.

FIG. 4B illustrates the positioning and components of the first housing 144a and the second housing 144b more fully. FIG. 4B illustrates a cross-sectional view the marine electronics device 140 shown in FIG. 3A taken along line B-B. As illustrated, the first housing 144a may extend around and enclose the second surface 142b of the screen 142 and abut the dash 162 on the customer facing side. The second housing 144b may extend over a portion of the first housing 144a and be attached thereto. In some embodiments, the first housing 144a may be a continuous surface, while in other embodiments the first housing 144a, may define an opening where the second housing 144b may be attached. In some embodiments, the second housing 144b may enclose a printed circuit board (PCB) 147 and other electronics. In this regard, as will be explained herein, the antenna 130 may be in data communication and/or electronic communication with the PCB 147.

In some embodiments, the antenna 130 may be more than one antenna 130. In this regard, one antenna 130 may be positioned on a first side of the frame 143 and a second antenna 130 may be positioned on a second side of the frame 143. In some embodiments, the antennas 130 may be positioned symmetrically on the frame 143, for example about a center line of the marine electronics device 140, while in other embodiments the antennas 130 may be off set from one another and may not be symmetrical over the center line.

FIG. 4C illustrates a zoomed in view of the position of the antenna 130 within marine electronics device 140. In some embodiments, the antenna 130 may include a cable 135 extending from the antenna 130 to the PCB, or other electronics device to provide data communication and/or electrical communication between the antenna 130 and the PCB. In this regard, the cable 135 may extend through the first housing 144a into the second housing 144b.

As illustrated, the antenna 130 may be spaced apart from the housing 144 such that the antenna 130 may emit and receive radio waves without interference. To further increase the effectiveness, and to decrease interference from the metal dash 162, the antenna 130 may be spaced apart from the dash 162 by a second distance D₂. The second distance D₂ comprises the first housing 144a, the space between the antenna and the housing 144, and any space between the first housing 144a and the dash 162. In some embodiments, the second distance D₂ may be less than 20 mm, preferably less than 15 mm, and more preferably less than 10 mm. However, other distances are contemplated.

To explain further, the antenna 130 and the dash 162 may be separated by the second distance D₂, while the first housing 144a and the dash 162 may be separated by the first distance D₁. In this regard, the first distance D₁ may be smaller than the second distance D₂ as the second distance D₂ includes the first distance D₁. In some embodiments, the second distance D₂ may be sized minimize interference between the dash 162 and the antenna 130. Additionally, the type of antenna 130 and configuration thereof may be utilized to further reduce interference.

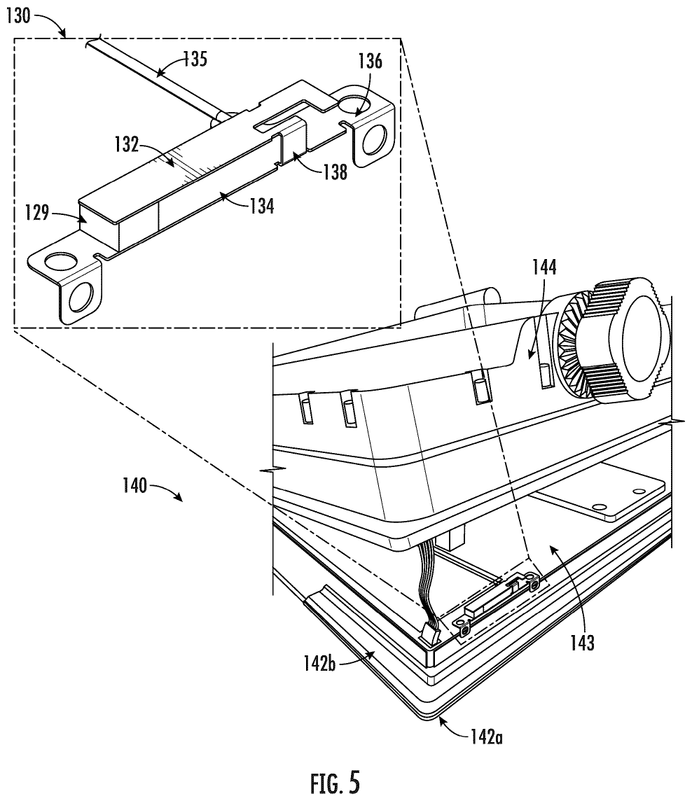

FIG. 5 illustrates the antenna and the position of the antenna within the marine electronics device. In some embodiments, the antenna 130 may be a planar inverted F antenna (PIFA). In some embodiments, the antenna 130 may define a ground portion 134 and a radiating element 132 attached via a vertical portion 138. In some embodiments, the ground portion 134 and the radiating element 132 may extend in parallel planes.

In some embodiments, the conductive potion 132 may be a radiator or similar. The radiating element 132 may be configured with a length and a width for the resonate operating frequency of the antenna 130. The radiating element 132 may radiate and/or receive electromagnetic waves at the operating frequency.

The ground portion 134 may extend in a plane parallel to the radiating element 132. In some embodiments, the ground portion 134 may comprise one or more connection points 136. The one or more connection points 136 may provide an opening for the antenna 130 to be secured to the frame mount (e.g., 148 FIG. 4A) via a fastener. In some embodiments, the fastener may be a screw, bolt or similar physical connector, while in other embodiments the fastener may be an adhesive, or mechanical weld.

The ground portion 138 may be configured a reference point for radiation of the antenna 130. The size of the ground portion may affect the impedance matching, the bandwidth, and the radiation pattern of the antenna 130. In some embodiments a larger ground plane may improve the antennas performance, and bandwidth. The position of the antenna 130 on the second surface of the LCD screen 142b allows the ground portion 138 of the antenna 130 to extend in the same plane as the second surface of the LCD screen 142b. Since the second surface of the LCD 142b is a conductive material the second surface of the LCD screen 142b acts as an extension of the ground portion 138 and thereby improves the performance of the antenna.

The antenna 130 may further comprise a shoring strip 138 connecting the radiating element 132 and the ground portion 134. The shorting strip 138 is configured to adjust the electrical length of the antenna 130. In some embodiments, the antenna 130 may further comprise a feed point connecting the conducting portion 132 to the cable 135. In this regard, feed point may be the access point between the radio frequency signal and the antenna 130. The feed point may provide the impedance matching and radiation characteristics.

In some embodiments, a stabilizer 129 may be positioned between the radiating element 132 and the ground portion 134. The stabilizer 129 may be positioned opposite the shoring strip 138. In some embodiments, the stabilizer 129 may prevent excess movement of the radiating element 132 and may provide support to the antenna 130. In some embodiments, the stabilizer 129 may be a non-conductive material such that the use thereof does not impair the performance of the antenna 130.

As discussed herein, in some embodiments the marine electronics device 140 may comprise one or more antennas 130 positioned within the housing 140. In some embodiments, a first antenna 130 may be positioned on a first side edge of the frame (e.g., attached to the frame mount 138) and a second antenna 130 may be positioned on a second side edge of the frame. The first edge may be one of a top edge, a first side edge, a second side edge or a bottom edge, similarly, the second edge may be one of the top edge, the first side edge, the second side edge, or the bottom edge providing the first edge and the second edge are different. In some embodiments, the first edge and the second edge may be opposite, for example, a top edge and a bottom edge, or a first side edge and a second side edge, while in other embodiment the first edge and the second edge may be adjacent, for example, the top edge and the first side edge, or the top edge and the second side edge, etc.

In some embodiments, the first antenna 130 and the second antenna 130 may be symmetrical about a centerline of the marine electronics device, such that both antennas may be positioned towards a top of the side edges of the LCD screen, both antennas may be positioned towards the bottom of the side edges of the LCD screen, or both antennas may be positioned towards the middle of the side edges of the LCD screen. Alternatively, in some embodiments the antennas 130 are not symmetrical about the centerline of the marine electronics device. In this regard, a first antenna may be positioned towards the top of the side edge of the LCD screen, and a second antenna may be positioned either towards the center of or the bottom of the second side edge of the LCD screen.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A marine electronics device for mounting in a dash of a watercraft, the marine electronics device comprising:
a liquid crystal display (LCD) comprising a screen defining a first surface opposing a second surface, and a frame attached to the second surface of the screen, wherein the frame is conductive;
at least one antenna element attached to the frame of the LCD, wherein the at least one antenna element defines a radiating element for transmitting and receiving a wireless signal and a ground portion, wherein the radiating element and the ground portion extend in parallel planes, and wherein the ground portion is attached to and in electrical communication with the frame of the LCD; and
a cable extending from the ground of the at least one antenna element wherein the cable enables data communication between the at least one antenna element and a printed circuit board.

2. The marine electronics device of claim 1, wherein the at least one antenna element is a planar inverted F antenna.

3. The marine electronics device of claim 1, further comprising a support positioned between the ground portion and the radiating element of the at least one antenna element.

4. The marine electronics device of claim 3, wherein the support is a non-conductive material.

5. The marine electronics device of claim 1, wherein the at least one antenna element is a first antenna and a second antenna, wherein the first antenna is positioned on a first edge of the frame and the second antenna is positioned on a second edge of the frame, wherein the first edge and the second edge are different.

6. The marine electronics device of claim 5, wherein the first edge and the second edge are opposite.

7. The marine electronics device of claim 1, further comprising a housing, wherein the housing encloses the frame and the second surface of the LCD.

8. The marine electronics device of claim 7, wherein the housing circumscribes the first surface of the LCD.

9. The marine electronics device of claim 7, wherein the housing further encloses the printed circuit board.

10. The marine electronics device of claim 7, wherein the housing is comprised of a dielectric material.

11. The marine electronics device of claim 10, wherein the housing is plastic.

12. An assembly arranged inside a housing of an electronics device for mounting within a dash of a watercraft, the assembly comprising:
a display defining a first surface and a second surface opposite the first surface;
a frame attached to the second surface of the display, wherein the frame is conductive;
an antenna element having a radiating element for transmitting and receiving a wireless signal and a ground portion, wherein the radiating element and the ground portion extend in parallel planes, wherein the ground portion is attached to and in electrical communication with the frame; and
an antenna signal feeding line coupled to the antenna element, wherein the antenna signal feeding line is in data communication with a printed circuit board.

13. The assembly of claim 12, wherein the antenna element is a planar inverted F antenna.

14. The assembly of claim 12, wherein the antenna element is a first antenna and a second antenna, wherein the first antenna is connected to a first edge of the frame and the second antenna is attached to a second edge of the frame, wherein the first edge and the second edge are different.

15. The assembly of claim 12, further comprising a support positioned between the radiating element and the ground portion of the antenna element.

16. The assembly of claim 12, wherein the housing is comprised of a dielectric material.

17. A marine electronics device positioned in a metal dash of a watercraft, the marine electronics device comprising:
a liquid crystal display (LCD) comprising a screen defining a first surface opposing a second surface, and a frame attached to the second surface of the screen, wherein the frame is conductive;
at least one planar inverted F antenna (PIFA) element attached to the frame of the LCD, wherein the at least one PIFA element defines a radiating element for transmitting and receiving a wireless signal and a ground portion, wherein the radiating element and the ground portion extend in parallel planes, and wherein the ground portion is attached to and in electrical communication with the frame of the LCD;
a cable extending from the ground portion of the at least one PIFA element, wherein the cable enables data communication between the at least one PIFA element and a printed circuit board.

18. The marine electronic device of claim 17, further comprising a support positioned between the ground portion and the radiating element of the PIFA element.

19. The marine electronics device of claim 18, wherein the support is a non-conductive material.

20. The marine electronics device of claim 17, wherein the at least one PIFA element is a first PIFA and a second PIFA, wherein the first PIFA is positioned on a first edge of the frame and the second PIFA is positioned on a second edge of the frame, wherein the first edge and the second edge are different.
